(19) United States
(12) Patent Application Publication
(10) Pub. No.: US 2026/0061818 A1
(43) Pub. Date: Mar. 5, 2026

(54) PICKUP TRUCK

(71) Applicant: TOYOTA JIDOSHA KABUSHIKI KAISHA, Toyota-shi Aichi-ken (JP)

(72) Inventors: Michio YOSHIDA, Susono-shi (JP); Tomoaki YANAGIDA, Susono-shi (JP); Taku SEGAWA, Numazu-shi (JP); Yoshiteru INAMOTO, Toyota-shi (JP); Takumi JINMON, Ann Arbor, MI (US); Taesoo KIM, Ann Arbor, MI (US); Jason CREMER, Stockbridge, MI (US); Takehito YODA, Novi, MI (US); David NAKAYAMA, Canton, MI (US); Ryan HARRIS, Saline, MI (US); Juan VELASCO, Ypsilanti, MI (US)

(73) Assignee: TOYOTA JIDOSHA KABUSHIKI KAISHA, Toyota-shi Aichi-ken (JP)

(21) Appl. No.: 19/309,992

(22) Filed: Aug. 26, 2025

(30) Foreign Application Priority Data
Aug. 29, 2024 (JP) 2024-147282

(51) Int. Cl. B60K 1/04

(52) U.S. Cl. CPC B60K 1/04; B60K 2001/0416

(57) ABSTRACT

A pickup truck includes a battery mount arranged at a front portion of a cargo bed in which the drive battery is mounted on the battery mount and the drive battery supplies driving electric power. The battery mount is divided into a first region having an upper surface and a second region having an upper surface that is located downward from the upper surface of the first region.

### CROSS-REFERENCE TO RELATED APPLICATIONS

This application is based upon and claims the benefit of priority from Japanese Patent Application No. 2024-147282 filed on Aug. 29, 2024, the entire contents of which are incorporated herein by reference.

### BACKGROUND

### 1. Field

The following description relates to a pickup truck.

### 2. Description of Related Art

An electric vehicle and a plug-in hybrid vehicle are electrically driven by an on-board large-capacity battery that supplies electric power to a motor. U.S. Patent Application Publication No. 2019/016231 discloses a pickup truck constructed as an electric vehicle. The pickup truck includes a drive battery installed at a front portion of a cargo bed.

In the conventional pickup truck, the battery for a drive system occupies the front portion of the cargo bed. This reduces the space provided by the cargo bed for cargo in the front-rear direction. Thus, the cargo bed may not be able to carry cargo having long dimensions. In this manner, the drive battery adversely affects the cargo loading capability.

### SUMMARY

This Summary is provided to introduce a selection of concepts in a simplified form that are further described below in the Detailed Description. This Summary is not intended to identify key features of the claimed subject matter, nor is it intended to be used as an aid in determining the scope of the claimed subject matter.

In one general aspect, a pickup truck including a drive battery is configured to supply driving electric power. The pickup truck includes a battery mount arranged at a front portion of a cargo bed in which the drive battery is mounted on the battery mount, and the battery mount is divided into a first region and a second region in a transverse direction, in which the first region and the second region each include an upper surface, and the upper surface of the second region is located downward from the upper surface of the first region.

Other features and aspects will be apparent from the following detailed description, the drawings, and the claims.

### BRIEF DESCRIPTION OF THE DRAWINGS

FIG. 1 is a side view illustrating the layout of elements in a first embodiment of a pickup truck.

FIG. 2 is a plan view illustrating the layout of a drive system, a frame, an exhaust pipe, a fuel tank, and the like in the pickup truck of FIG. 1.

FIG. 3 is a plan view illustrating a cargo bed and the periphery of the cargo bed in the pickup truck of FIG. 1.

FIG. 4 is a perspective view illustrating the cargo bed and the periphery of the cargo bed in the pickup truck in FIG. 1 in a transparent state.

FIG. 5 is a perspective view illustrating the cargo bed in a second embodiment of the pickup truck in a transparent state.

FIG. 6 is a perspective view illustrating the cargo bed of the pickup truck in a first modified example in a transparent state.

FIG. 7 is a perspective view illustrating the cargo bed of the pickup truck in a second modified example in a transparent state.

FIG. 8 is a side view illustrating a drive battery of the pickup truck in a third modified example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

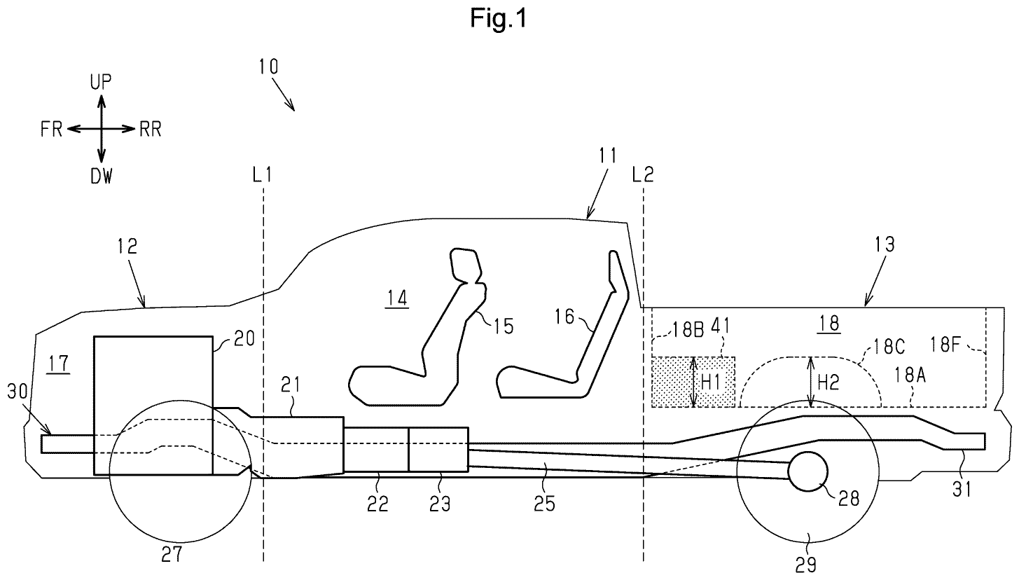

A first embodiment of a pickup truck will now be described with reference to FIGS. 1 to 4. The arrows labeled “FR”, “RR”, “UP”, “DW”, “LF”, and “RF” indicate the frontward, rearward, upward, downward, leftward, and rightward directions, respectively, using the forward moving direction of the vehicle as the frame of reference. A pickup truck 10 of the present embodiment is a plug-in hybrid electric vehicle (PHEV).

As shown in FIG. 1, the pickup truck 10 is a PHEV. The pickup truck 10 includes three sections, a cabin section 11, a front section 12 located in the frontward direction FR from the cabin section 11, and a cargo section 13 located in the rearward direction RR from the cabin section 11. The cabin section 11 includes a passenger compartment 14 where the vehicle occupants are accommodated. The passenger compartment 14 includes a front seat 15 and a rear seat 16 located in the rearward direction RR from the front seat 15. The front section 12 includes an engine compartment 17 in which a longitudinal engine 20 is arranged. In the pickup truck 10 of the present embodiment, the engine 20 has cylinders in a V-shaped arrangement. The cargo section 13 includes a cargo bed 18 that is open in the upward direction UP. The left and right sides of the cargo bed 18 each include a wheel housing 18C to accommodate a left or right rear wheel 29. In the drawings, a boundary between the cabin section 11 and the front section 12 is indicated by a broken line L1. Further, a boundary between the cabin section 11 and the cargo section 13 is indicated by a broken line L2.

### Structure of Drive System of Pickup Truck

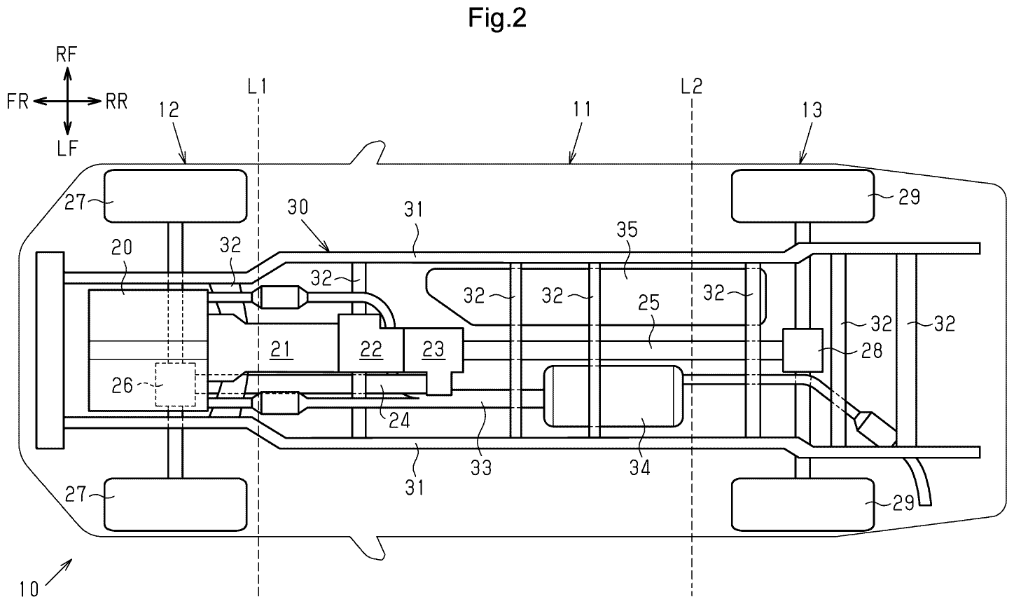

The structure of a drive system of the pickup truck 10 will now be described with reference to FIG. 2. The drive system of the pickup truck 10 includes the engine 20, a transmission 21, a motor 22, and a transfer case 23. The motor 22 includes the functionality for generating rotational power for driving the pickup truck 10 in accordance with the supplied power and the functionality for generating electric power from the rotation of the engine 20 or the wheels. Further, the drive system of the pickup truck 10 includes a drive shaft 24 for front wheels and a drive shaft 25 for rear wheels. The drive shafts 24 and 25 are each connected to the engine 20 by the transfer case 23, the motor 22, and the transmission 21. Further, the drive shaft 24 for the front wheels is connected to left and right front wheels 27 by a differential 26. Furthermore, the drive shaft 25 for the rear wheels is connected to the left and right rear wheels 29 by a differential 28. Additionally, the drive shaft 25 for the rear wheels guides the rotational power from the engine 20 and the motor 22 to the rear wheels 29.

### Underfloor Structure of Pickup Truck

An underfloor structure of the pickup truck 10 will now be described with reference to FIG. 2.

A frame 30 is arranged under a floor of the passenger compartment 14 and the cargo bed 18. The frame 30 is a ladder-shaped frame that includes left and right side members 31 and cross members 32 connecting the two side members 31. The left and right side members 31 extend in the front-rear direction and are located in the downward direction DW from the passenger compartment 14 of the cabin section 11. As shown in FIG. 2, the drive shaft 25 for the rear wheels extend in the front-rear direction and are located in the downward direction DW from the passenger compartment 14 of the cabin section 11.

Further, an exhaust pipe 33 is arranged under the floor of the pickup truck 10 to guide exhaust gas from the engine 20 in the rearward direction RR. The exhaust pipe 33 extends in the front-rear direction and is located in the downward direction DW from the passenger compartment 14 of the cabin section 11. A muffler 34 is arranged on the exhaust pipe 33. The muffler 34 is located in the downward direction DW from the passenger compartment 14 of the cabin section 11. Furthermore, a fuel tank 35, containing fuel for the engine 20, is arranged under the floor of the pickup truck 10. The drive shaft 25 for the rear wheels is arranged between the exhaust pipe 33 and the fuel tank 35 in the transverse direction.

### Layout of Drive Battery

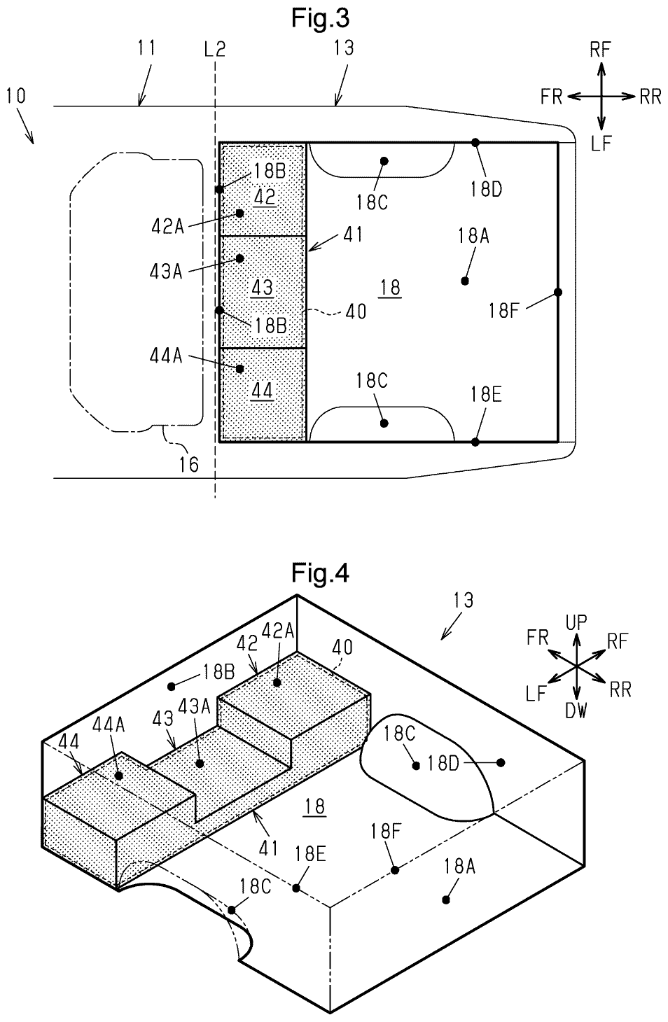

The pickup truck 10 includes a drive battery 40 that supplies electric power to the motor 22. The layout of the drive battery 40 in the pickup truck 10 will now be described with reference to FIGS. 3 and 4.

As shown in FIG. 3, a battery mount 41 where the drive battery 40 is mounted, is arranged at a front portion of the cargo bed 18. In the present embodiment, the battery mount 41 is located in the frontward direction FR from the wheel housings 18C. Further, in the present embodiment, the battery mount 41 is arranged in contact with a front wall surface 18B, a right wall surface 18D, and a left wall surface 18E of the cargo bed 18. In the drawings, a rear wall surface 18F of the cargo bed 18 is also shown.

As shown in FIG. 4, the battery mount 41 is divided into three regions 42 to 44 having different heights and arranged in the transverse direction. Among the three regions 42 to 44, the region 43 is located in the central part in the transverse direction. The height of the region 43 is lower than the regions 42 and 44. In other words, the region 43 includes an upper surface 43A that is located in the downward direction DW from an upper surface 42A of the region 42 and an upper surface 44A of the region 44. In the pickup truck 10 of the present embodiment, the regions 42 and 44 each correspond to a first region. The region 43, which includes the upper surface 43A that is located in the downward direction DW from the upper surfaces 42A and 44A of the first region, corresponds to a second region. In this manner, the battery mount 41 in the pickup truck 10 of the present embodiment includes the two first regions that are spaced apart from each other with the second region located in between. The battery mount 41 is shaped by recessing its transverse central part in the downward direction DW.

As shown in FIG. 1, in the present embodiment, the upper surfaces 42A and 44A of the regions 42 and 44, each corresponding to the first region, is located at height H1. The top of the wheel housing 18C is located at height H2, which is the same as height H1. Height H1 is the distance from a floor panel 18A of the cargo bed 18 to the upper surfaces 42A and 44A in the vertical direction. Further, height H2 is the distance from the floor panel 18A of the cargo bed 18 to the top of the wheel housing 18C in the vertical direction.

### Operation of First Embodiment

The frame 30, the drive shaft 25, the exhaust pipe 33, the fuel tank 35, and the like are arranged under the floor of the PHEV pickup truck 10. Therefore, it is difficult to provide sufficient space under the floor of the pickup truck 10 for the drive battery 40, which supplies driving electric power to the motor 22. In this regard, in the present embodiment, the battery mount 41, which is where the drive battery 40 is mounted, is located at the front portion of the cargo bed 18. Thus, even if the pickup truck 10 is a PHEV, the large-capacity drive battery 40, which has a large capacity and a large size, can be installed in the pickup truck 10.

The battery mount 41 is divided into the regions 42 and 44, which are located at the two opposite sides of the cargo bed 18 in the transverse direction, and the region 43, which is located at the transverse central part of the cargo bed 18 in the downward direction DW from the upper surfaces 42A and 44A of the regions 42 and 44. Thus, the battery mount 41 is shaped by recessing its transverse central part in the downward direction DW. The height of the upper surfaces 42A to 44A of the regions 42 to 44 in the battery mount 41 is lower than the walls of the cargo bed 18. Thus, cargo can be placed on the battery mount 41. However, a step is formed between the floor panel 18A of the cargo bed 18 and the upper surfaces 42A to 44A of the battery mount 41. When there is a large step on the cargo bed 18, the arrangement of cargo over the step is difficult.

A battery mount for mounting a drive battery having the same capacity as the drive battery 40 of the present embodiment may have an upper surface with a uniform height. In this example, the upper surface of the battery mount is higher than the battery mount 41 of the present embodiment, and thus located in the upward direction UP from the upper surface 43A of the region 43, which is the central part of the battery mount 41 in the transverse direction. In this manner, the upper surface of the battery mount having a uniform height will form a large step between the battery mount 41 and the floor panel 18A. In this regard, in the present embodiment, the battery mount 41 is divided into the regions 42 to 44 having the upper surfaces 42A to 44A of different heights. This allows the battery mount 41 to include a portion forming a small step between the floor panel 18A and the battery mount 41. In the present embodiment, the region 43 of the battery mount 41, which is located at the transverse central part, is where the small step is formed. In this case, the pickup truck 10 includes a portion where there is no large step at the transverse central part of the cargo bed 18 from the front end to the rear end of the cargo bed 18.

Cargo is difficult to place on the upper surfaces 42A and 44A of the regions 42 and 44 since the two opposite sides of the battery mount 41 in the transverse direction are located in the upward direction UP from the region 43. The regions 42 and 44 are located in the frontward direction FR from the right and left wheel housings 18C. Further, height H1 of the upper surfaces 42A and 44A of the regions 42 and 44 is equal to height H2 of the wheel housing 18C. The wheel housing 18C bulges in the upward direction UP from the floor panel 18A. Thus, in any case, the sections located in the frontward direction FR from the wheel housings 18C of the cargo bed 18 is where the arrangement of cargo is difficult. Therefore, the tall regions 42 and 44 have a limited effect on the cargo loading capability of the cargo bed 18.

### Aspects of First Embodiment

The pickup truck 10 of the present embodiment has the aspects described below.

(1) The pickup truck 10 of the present embodiment includes the battery mount 41, which is where the drive battery 40 is mounted, at the front portion of the cargo bed 18. Thus, even if the pickup truck 10 is a PHEV, the pickup truck 10 provides sufficient space for installing the large capacity drive battery 40.

(2) The battery mount 41 is divided into the regions 42 and 44, and the region 43 in the transverse direction. The region 43 includes the upper surface 43A located in the downward direction DW from the upper surfaces 42A and 44A of the regions 42 and 44. The cargo bed 18 can carry cargo having relatively long dimensions. Therefore, in the pickup truck 10 of the present embodiment, the arrangement of the drive battery 40 on the cargo bed 18 has a limited effect on the cargo loading capability.

(3) In the battery mount 41, the two regions 42 and 44, which include the upper surfaces 42A and 44A, are located in the upward direction UP from the upper surface 43A of the region 43, and spaced apart from each other by the region 43. The battery mount 41 is shaped by recessing its transverse central part in the downward direction DW. Thus, cargo having relatively long dimensions can be carried in a facilitated manner on the cargo bed 18 at the transverse central part.

(4) The battery mount 41 is arranged in the frontward direction FR from the wheel housings 18C of the cargo bed 18. The battery mount 41 is not arranged in a rear portion of the cargo bed 18, where cargo can be easily loaded and unloaded. Thus, when the battery mount 41 is arranged at the front portion of the cargo bed 18, the arrangement of the drive battery 40 has a smaller effect on the cargo loading capability of the cargo bed 18 than when the drive battery 40 is arranged in the rear portion of the cargo bed 18.

(5) The regions 42 and 44 having the upper surfaces 42A and 44A, which are located in the upward direction UP from the upper surface 43A of the region 43, are located in the frontward direction FR from the wheel housings 18C of the cargo bed 18. The upper surfaces 42A and 44A of the regions 42 and 44 form steps projecting from the floor panel 18A that are larger than the step formed by the upper surface 43A of the region 43. Therefore, the arrangement of cargo is difficult at the regions 42 and 44. That is, the parts in the frontward direction FR from the wheel housings 18C of the cargo bed 18 are where the arrangement of cargo is difficult. Thus, even if the regions 42 and 44 are located at the part in the frontward direction FR from the wheel housings 18C, the effect on the cargo loading capability is limited. Accordingly, the effect on the cargo loading capability of the cargo bed 18 is reduced compared to when the regions 42 and 44 are located at other positions.

(6) Height H1 of the regions 42 and 44 is the same as height H2 of the wheel housings 18C. When height H1 of the regions 42 and 44 differs from height H2 of the wheel housings 18C, steps are formed and the arrangement of cargo at the two opposite sides of the cargo bed 18 in the transverse direction becomes difficult. In this regard, in the present embodiment, height H1 of the regions 42 and 44 is the same as height H2 of the wheel housings 18C. Thus, cargo can be readily arranged at the two opposite sides of the cargo bed 18.

### Second Embodiment

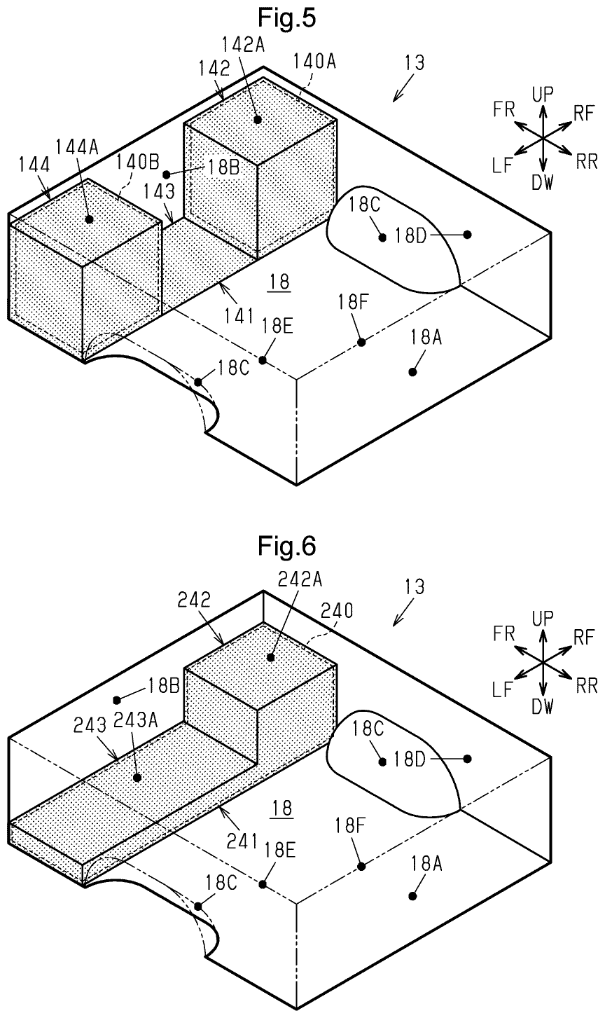

A second embodiment of the pickup truck 10 will now be described with reference to FIG. 5. In the present embodiment, same reference numbers are given to those elements that are the same as the above embodiment. Such elements will not be described in detail.

As shown in FIG. 5, in the present embodiment, a battery mount 141 is also installed at the front portion of the cargo bed 18. In the present embodiment, the drive battery is separated into drive batteries 140A and 140B that are mounted on the battery mount 141 at the two opposite sides in the transverse direction. The battery mount 141 is divided into regions 142, 144, and 143 in the transverse direction. The regions 142 and 144 located at the two opposite sides in the transverse direction accommodate the drive batteries 140A and 140B. The region 143 is located at the transverse central part and does not include the drive batteries 140A and 140B. The region 143 does not include any elements on the floor panel 18A of the cargo bed 18. Thus, the floor panel 18A defines the upper surface of the region 143. The upper surface of the region 143 is located in the downward direction DW from the upper surfaces 142A and 144A of the regions 142 and 144, which is where the drive batteries 140A and 140B are installed. In the present embodiment, the regions 142 and 144 located at the two opposite sides of the battery mount 141 in the transverse direction each correspond to the first region. The region 143 located at the transverse central part corresponds to the second region. Further, among the first regions and the second region, the battery mount 141 of the present embodiment includes the drive batteries 140A and 140B only in the first regions.

The pickup truck described above includes a stepless portion extending in the transverse central part of the cargo bed 18 from the front end to the rear end of the cargo bed 18. The pickup truck of the present embodiment has aspects that are the same or similar to aspects (1) to (5), which are described above.

### OTHER EMBODIMENTS

The above embodiments may be modified as described below. The above embodiments and the following modifications may be combined as long as there is technical consistency.

### Battery Mount

In the battery mount 41 of the first embodiment, height H1 of the upper surfaces 42A and 44A of the regions 42 and 44 may differ from height H2 of the wheel housings 18C.

The battery mounts 41 and 141 of the above embodiments are divided into the first regions, which are the regions located at the two opposite sides in the transverse direction, and the second region, which is the region located at the transverse central part and includes an upper surface located in the downward direction DW from the upper surfaces of the first regions. The battery mounts may be divided into the first and second regions in a different manner. For example, as shown in FIG. 6, a battery mount 241 where a drive battery 240 is mounted, is located at the front portion of the cargo bed 18. Further, the battery mount 241 is divided into a first region 242 and a second region 243. The first region 242 is located in the rightward direction RF. The second region 243 is located in the leftward direction LF and includes an upper surface 243A that is located in the downward direction DW from an upper surface 242A of the first region 242. In this manner, the first and second regions may be changed in number and shape. For example, the first region may be arranged at a part other than the two opposite sides of the battery mount in the transverse direction. In this case, the first region is arranged at a location separated from the wheel housings 18C in the frontward direction FR.

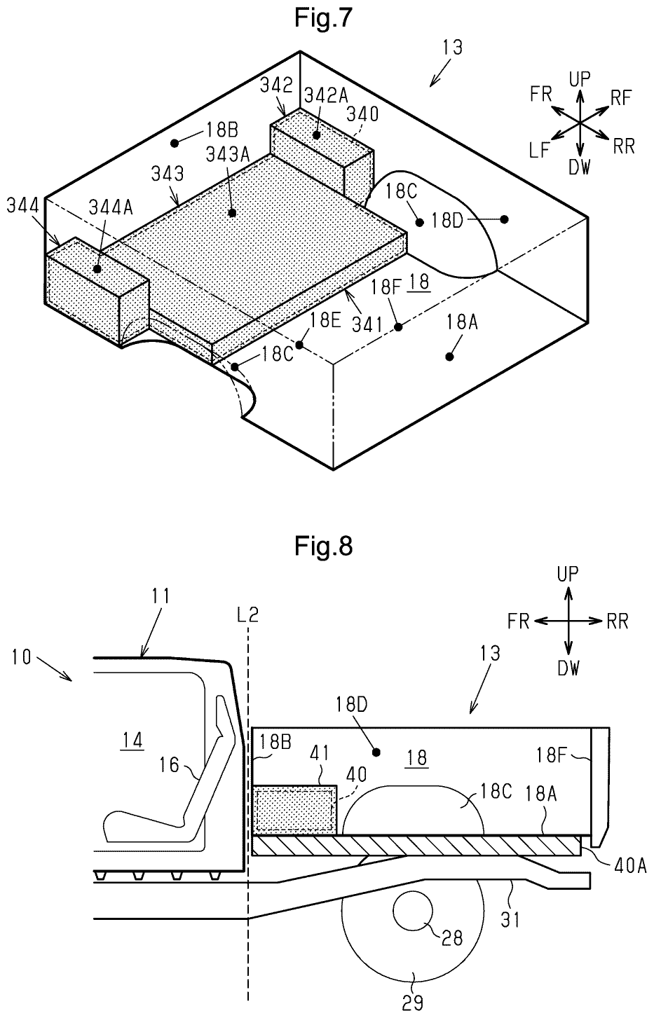

In the above embodiments, the battery mounts 41, 141, and 241 are arranged to be within an area located in the frontward direction FR from the wheel housings 18C of the cargo bed 18. However, a battery mount may be arranged to partially extend out of such area in the rearward direction RR. For example, as shown in FIG. 7, a battery mount 341 where a drive battery 340 is mounted, is located at the front portion of the cargo bed 18. Further, the battery mount 341 is divided into first regions 342 and 344, which are located at the two opposite sides in the transverse direction, and a second region 343, which is located in the transverse central part. The second region 343 includes an upper surface 343A located in the downward direction DW from upper surfaces 342A and 344A of the first regions 342 and 344. In the battery mount 341, the first regions 342 and 344 are located at the two opposite sides in the transverse direction and in the frontward direction FR from the wheel housings 18C. The second region 343 extends in the rearward direction RR from the first regions 342 and 344.

In the above embodiments, the battery mounts 41, 141, 241, and 341 are each arranged in contact with the front wall surface 18B, the right wall surface 18D, and the left wall surface 18E of the cargo bed 18. The battery mounts may be arranged so that the battery mounts are separated from some or all of the wall surfaces 18B, 18D, and 18E.

As shown in FIG. 8, a drive battery 40A may be arranged under the floor of the pickup truck. In FIG. 8, the battery mount 41, which is similar to that of the first embodiment, is arranged at the front portion of the cargo bed 18. Further, the drive battery 40A, which is separate from the drive battery 40 mounted on the battery mount 41, is arranged in the downward direction DW from the floor panel 18A of the cargo bed 18. In this manner, the pickup truck may include an additional drive battery, which supplies driving electric power and is separate from the drive battery mounted on the battery mount, under the floor of the pickup truck.

### OTHER MODIFICATIONS

The engine 20 does not have to be of a type with a V-shaped cylinder arrangements. Further, the engine 20 may be arranged in the transverse direction in the engine compartment 17.

The layout of the drive shaft 25, the exhaust pipe 33, the muffler 34, the fuel tank 35, and the like under the floor the pickup truck 10 may be modified.

The structure of the drive system in the pickup truck 10 may be modified. For example, the pickup truck 10 may be a front-wheel drive vehicle or may include independent drive systems provided for the front wheels 27 and the rear wheels 29.

The pickup truck 10 may be a battery electric vehicle that does not include the engine 20.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A pickup truck including a drive battery configured to supply driving electric power, the pickup truck comprising:
a battery mount arranged at a front portion of a cargo bed, wherein the drive battery is mounted on the battery mount, and the battery mount is divided into a first region and a second region in a transverse direction, and
wherein the first region and the second region each include an upper surface, and the upper surface of the second region is located downward from the upper surface of the first region.

2. The pickup truck according to claim 1, wherein among the first region and the second region, the drive battery is installed in only the first region.

3. The pickup truck according to claim 1, wherein the first region comprises two regions spaced apart from each other with the second region interposed therebetween.

4. The pickup truck according to claim 1, wherein
the cargo bed includes a wheel housing accommodating a rear wheel, and
the battery mount is arranged frontward from the wheel housing of the cargo bed.

5. The pickup truck according to claim 1, wherein
the cargo bed includes a wheel housing accommodating a rear wheel, and
the first region is located frontward from the wheel housing of the cargo bed.

6. The pickup truck according to claim 5, wherein a height of the first region is the same as a height of the wheel housing.

7. The pickup truck according to claim 1, further comprising an additional drive battery, that is configured to supply driving electric power and separate from the drive battery, is arranged under a floor of the pickup truck.

8. The pickup truck according to claim 1, further comprising:
a fuel tank;
an engine;
a motor;
a transmission;
a drive shaft connected to the engine by the motor and the transmission to transmit rotational power generated by the engine and the motor to a rear wheel;
an exhaust pipe configured to guide exhaust gas rearward from the engine;
a cabin section including a passenger compartment;
a front section located frontward from the cabin section and including an engine compartment where the engine is arranged longitudinally;
a cargo section located rearward from the cabin section and including the cargo bed; and
a frame including left and right side members extending in a front-rear direction and located downward from the passenger compartment of the cabin section,
wherein the drive shaft and the exhaust pipe extend in the front-rear direction and are located downward from the passenger compartment of the cabin section.
